(19) United States
(12) Patent Application Publication
(10) Pub. No.: US 2019/0104141 A1
(43) Pub. Date: Apr. 4, 2019

(54) System and Method for Providing and Facilitating an Information Security Marketplace

(71) Applicants: Zuk Avraham, Philadelphia, PA (US); Taly Slachevsky, Philadelphia, PA (US); Nir Avraham, Philadelphia, PA (US)

(72) Inventors: Zuk Avraham, Philadelphia, PA (US); Taly Slachevsky, Philadelphia, PA (US); Nir Avraham, Philadelphia, PA (US)

(21) Appl. No.: 16/149,847

(22) Filed: Oct. 2, 2018

Related U.S. Application Data
(60) Provisional application No. 62/566,926, filed on Oct. 2, 2017.

(51) Int. Cl. H04L 29/06; G06Q 30/06

(52) U.S. Cl. CPC H04L 63/1416; H04L 63/1441; G06Q 30/0627

(57) ABSTRACT

Malware detection is provided via a marketplace for the analyzing and remediating of cyber-related threats and disseminating related resolution templates. An information security marketplace facilitates the ability to monetize the information obtained through and generated by an incoming attack on an organization. Actionable reports are sold to other organizations in the same market segment or region (e.g. one carrier will buy from other carriers in the same region), or AV vendors, or companies that are interested to buy such threat intelligence information, indicators, etc.

### PRIORITY

This application claims the benefit of U.S. Provisional Application 62/566,926, filed Oct. 2, 2017, which is hereby incorporated by reference as submitted in its entirety.

### FIELD OF THE INVENTION

The present invention relates to malware detection, and, more particularly, to providing a marketplace and processes for the analyzing and remediating of cyber-related threats and disseminating related resolution templates.

The present invention also relates to the automated malware analysis, separation of different threat actors, automated triaging and anonymization of samples data.

### BRIEF SUMMARY OF THE INVENTION

In a world of on-going and continuous cyber-threats and intrusions, resources to protect assets and to resolve security breaches are stretched beyond capacity. Indeed, most companies and other organizations subject to phishing and/or direct cyber acts lack the will and/or financial resources to adequately monitor for, identify or resolve breaches. For at least these reasons, there exists a need to provide a marketplace and processes for efficient analysis of potential attacks, at scale, to allow for the resolving of cyber threats. One of the key elements to discovering the threat actors campaigns is to focus on the attackers' mistakes. However, most security organizations do not actively investigate the attackers' mistakes hence losing valuable insights on the existence of threat actors within the network and the Tactics, Techniques, and Procedures (TTPs) these actors leverage in their operations.

### BRIEF DESCRIPTION OF THE DRAWINGS

This disclosure is illustrated by way of example and not by way of limitation in the accompanying figure(s). The figure(s) may, alone or in combination, illustrate one or more embodiments of the disclosure. Elements illustrated in the figure(s) are not necessarily drawn to scale. Reference labels may be repeated among the figures to indicate corresponding or analogous elements.

The detailed description makes reference to the accompanying figures in which:

FIG. 1 is a block diagram of an exemplary computing system for use in accordance with herein described systems and methods;

FIG. 2 is a block diagram showing an exemplary networked computing environment for use in accordance with herein described systems and methods;

FIG. 3 is an illustration of an embodiment of the present invention;

FIG. 4 is an illustration of an embodiment of the present invention; and

FIG. 5 is an illustration of an embodiment of the present invention.

### DETAILED DESCRIPTION

The figures and descriptions provided herein may have been simplified to illustrate aspects that are relevant for a clear understanding of the herein described apparatuses, systems, and methods, while eliminating, for the purpose of clarity, other aspects that may be found in typical similar devices, systems, and methods. Those of ordinary skill may thus recognize that other elements and/or operations may be desirable and/or necessary to implement the devices, systems, and methods described herein. But because such elements and operations are known in the art, and because they do not facilitate a better understanding of the present disclosure, for the sake of brevity a discussion of such elements and operations may not be provided herein. However, the present disclosure is deemed to nevertheless include all such elements, variations, and modifications to the described aspects that would be known to those of ordinary skill in the art.

Embodiments are provided throughout so that this disclosure is sufficiently thorough and fully conveys the scope of the disclosed embodiments to those who are skilled in the art. Numerous specific details are set forth, such as examples of specific components, devices, and methods, to provide a thorough understanding of embodiments of the present disclosure. Nevertheless, it will be apparent to those skilled in the art that certain specific disclosed details need not be employed, and that exemplary embodiments may be embodied in different forms. As such, the exemplary embodiments should not be construed to limit the scope of the disclosure. As referenced above, in some exemplary embodiments, well-known processes, well-known device structures, and well-known technologies may not be described in detail.

Components, or modules, shown in diagrams are illustrative of exemplary embodiments of the invention and are meant to avoid obscuring the invention. It shall also be understood that throughout this discussion that components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” or “communicatively coupled” shall be understood to include direct connections, indirect connections through one or more intermediary devices, and wireless connections.

The use of certain terms in various places in the specification is for illustration and should not be construed as limiting. A service, function, or resource is not limited to a single service, function, or resource; usage of these terms may refer to a grouping of related services, functions, or resources, which may be distributed or aggregated.

The terms “messages,” “blocks,” and “data,” shall be understood to mean a group of bits, which may be transported across a network. These terms shall not be interpreted as limiting embodiments of the present invention to particular configuration; and, these terms along with similar terms such as “data,” “data traffic,” “information,” “cell,” etc. may be replaced by other terminologies referring to a group of bits, and may be used interchangeably. The terms “include,” “including,” “comprise,” and “comprising” shall be understood to be open terms and any lists the follow are examples and not meant to be limited to the listed items. Any headings used herein are for organizational purposes only and shall not be used to limit the scope of the description or the claims.

The terminology used herein is for the purpose of describing particular exemplary embodiments only and is not intended to be limiting. For example, as used herein, the singular forms “a,” “an,” and “the” may be intended to include the plural forms as well, unless the context clearly indicates otherwise. The terms “comprises,” “comprising,” “including,” and “having” are inclusive and therefore specify the presence of stated features, integers, steps, operations, elements, and/or components, but do not preclude the presence or addition of one or more other features, integers, steps, operations, elements, components, and/or groups thereof. The steps, processes, and operations described herein are not to be construed as necessarily requiring their respective performance in the particular order discussed or illustrated, unless specifically identified as a preferred or required order of performance. It is also to be understood that additional or alternative steps may be employed, in place of or in conjunction with the disclosed aspects.

When an element or layer is referred to as being “on,” “engaged to,” “connected to,” or “coupled to” another element or layer, it may be directly on, engaged, connected or coupled to the other element or layer, or intervening elements or layers may be present, unless clearly indicated otherwise. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). Further, as used herein the term “and/or” includes any and all combinations of one or more of the associated listed items.

Yet further, although the terms first, second, third, etc. may be used herein to describe various elements, components, regions, layers and/or sections, these elements, components, regions, layers and/or sections should not be limited by these terms. These terms may be only used to distinguish one element, component, region, layer or section from another element, component, region, layer or section. Terms such as “first,” “second,” and other numerical terms when used herein do not imply a sequence or order unless clearly indicated by the context. Thus, a first element, component, region, layer or section discussed below could be termed a second element, component, region, layer, or section without departing from the teachings of the exemplary embodiments.

A computer-implemented platform and methods of use are disclosed that provide networked access to a plurality of types of digital content, including but not limited to video, audio, and document content, and that track and deliver the accessed content, such as via one or more applications, or “apps.” Described embodiments are intended to be exemplary and not limiting. As such, it is contemplated that the herein described systems and methods can be adapted to provide many types of users with access and delivery of many types of domain data, and can be extended to provide enhancements and/or additions to the exemplary services described. The invention is intended to include all such extensions. Reference will now be made in detail to various exemplary and illustrative embodiments of the present invention.

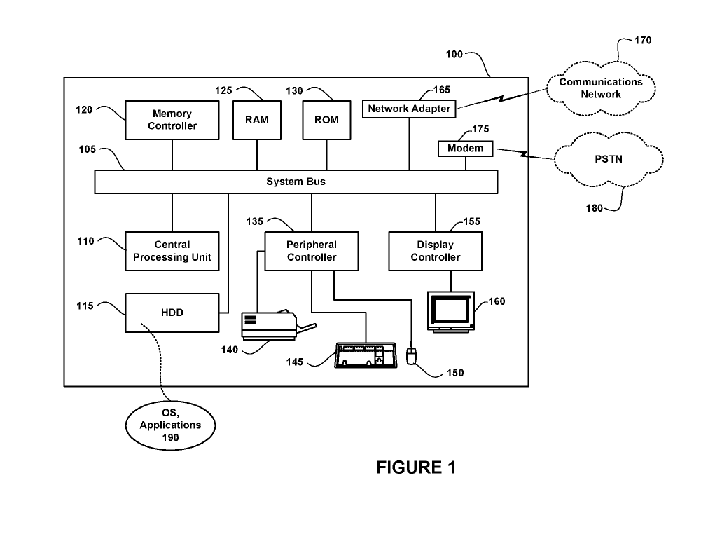

FIG. 1 depicts an exemplary computing system 100 that can be used in accordance with herein described system and methods. Computing system 100 is capable of executing software, such as an operating system (OS) and a variety of computing applications 190. The operation of exemplary computing system 100 is controlled primarily by computer readable instructions, such as instructions stored in a computer readable storage medium, such as hard disk drive (HDD) 115, optical disk (not shown) such as a CD or DVD, solid state drive (not shown) such as a USB “thumb drive,” or the like. Such instructions may be executed within central processing unit (CPU) 110 to cause computing system 100 to perform operations. In many known computer servers, workstations, personal computers, mobile devices, and the like, CPU 110 is implemented in an integrated circuit called a processor.

It is appreciated that, although exemplary computing system 100 is shown to comprise a single CPU 110, such description is merely illustrative as computing system 100 may comprise a plurality of CPUs 110. Additionally, computing system 100 may exploit the resources of remote CPUs (not shown), for example, through communications network 170 or some other data communications means.

In operation, CPU 110 fetches, decodes, and executes instructions from a computer readable storage medium such as HDD 115. Such instructions can be included in software such as an operating system (OS), executable programs, and the like. Information, such as computer instructions and other computer readable data, is transferred between components of computing system 100 via the system's main data-transfer path. The main data-transfer path may use a system bus architecture 105, although other computer architectures (not shown) can be used, such as architectures using serializers and deserializers and crossbar switches to communicate data between devices over serial communication paths. System bus 105 can include data lines for sending data, address lines for sending addresses, and control lines for sending interrupts and for operating the system bus. Some busses provide bus arbitration that regulates access to the bus by extension cards, controllers, and CPU 110. Devices that attach to the busses and arbitrate access to the bus are called bus masters. Bus master support also allows multiprocessor configurations of the busses to be created by the addition of bus master adapters containing processors and support chips.

Memory devices coupled to system bus 105 can include random access memory (RAM) 125 and read only memory (ROM) 130. Such memories include circuitry that allows information to be stored and retrieved. ROMs 130 generally contain stored data that cannot be modified. Data stored in RAM 125 can be read or changed by CPU 110 or other hardware devices. Access to RAM 125 and/or ROM 130 may be controlled by memory controller 120. Memory controller 120 may provide an address translation function that translates virtual addresses into physical addresses as instructions are executed. Memory controller 120 may also provide a memory protection function that isolates processes within the system and isolates system processes from user processes. Thus, a program running in user mode can normally access only memory mapped by its own process virtual address space; it cannot access memory within another process' virtual address space unless memory sharing between the processes has been set up.

In addition, computing system 100 may contain peripheral controller 135 responsible for communicating instructions using a peripheral bus from CPU 110 to peripherals, such as printer 140, keyboard 145, and mouse 150. An example of a peripheral bus is the Peripheral Component Interconnect (PCI) bus.

Display 160, which is controlled by display controller 155, can be used to display visual output generated by computing system 100. Such visual output may include text, graphics, animated graphics, and/or video, for example. Display 160 may be implemented with a CRT-based video display, an LCD-based display, gas plasma-based display, touch-panel, or the like. Display controller 155 includes electronic components required to generate a video signal that is sent to display 160.

Further, computing system 100 may contain network adapter 165 which may be used to couple computing system 100 to an external communication network 170, which may include or provide access to the Internet, and hence which may provide or include tracking of and access to the domain data discussed herein. Communications network 170 may provide user access to computing system 100 with means of communicating and transferring software and information electronically, and may be coupled directly to computing system 100, or indirectly to computing system 100, such as via PSTN or cellular network 180. For example, users may communicate with computing system 100 using communication means such as email, direct data connection, virtual private network (VPN), Skype or other online video conferencing services, or the like. Additionally, communications network 170 may provide for distributed processing, which involves several computers and the sharing of workloads or cooperative efforts in performing a task. It is appreciated that the network connections shown are exemplary and other means of establishing communications links between computing system 100 and remote users may be used.

It is appreciated that exemplary computing system 100 is merely illustrative of a computing environment in which the herein described systems and methods may operate and does not limit the implementation of the herein described systems and methods in computing environments having differing components and configurations, as the inventive concepts described herein may be implemented in various computing environments using various components and configurations.

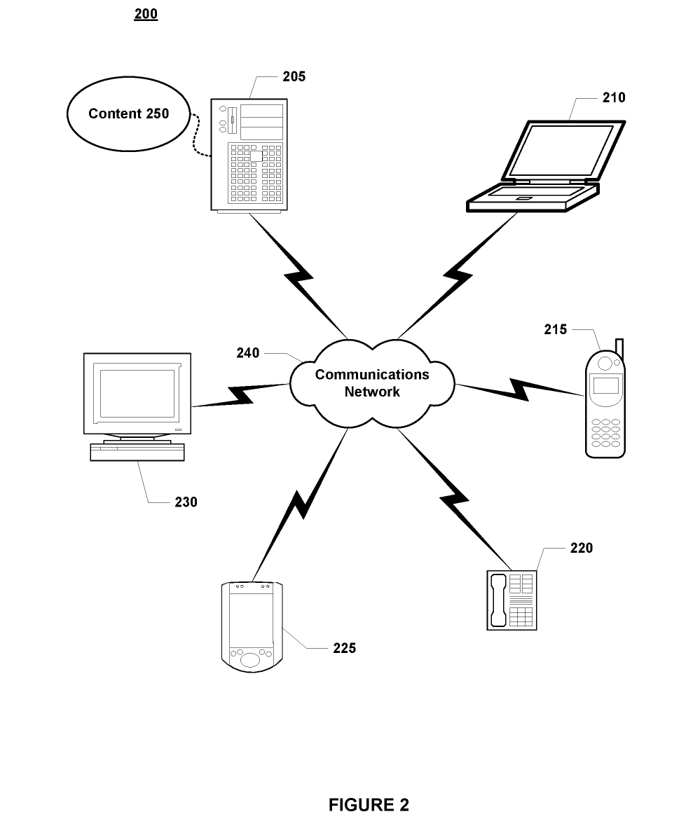

As shown in FIG. 2, computing system 100 can be deployed in networked computing environment 200. In general, the above description for computing system 100 applies to server, client, and peer computers deployed in a networked environment, for example, server 205, laptop computer 210, and desktop computer 230. FIG. 2 illustrates an exemplary illustrative networked computing environment 200, with a server in communication with client computing and/or communicating devices via a communications network, in which the herein described apparatus and methods may be employed.

As shown in FIG. 2, server 205 may be interconnected via a communications network 240 (which may include any of, or any combination of, a fixed-wire or wireless LAN, WAN, intranet, extranet, peer-to-peer network, virtual private network, the Internet, or other communications network such as POTS, ISDN, VoIP, PSTN, etc.) with a number of client computing/communication devices such as laptop computer 210, wireless mobile telephone 215, wired telephone 220, personal digital assistant 225, user desktop computer 230, and/or other communication enabled devices (not shown). Server 205 can comprise dedicated servers operable to process and communicate data such as digital content 250 to and from client devices 210, 215, 220, 225, 230, etc. using any of a number of known protocols, such as hypertext transfer protocol (HTTP), file transfer protocol (FTP), simple object access protocol (SOAP), wireless application protocol (WAP), or the like. Additionally, networked computing environment 200 can utilize various data security protocols such as secured socket layer (SSL), pretty good privacy (PGP), virtual private network (VPN) security, or the like. Each client device 210, 215, 220, 225, 230, etc. can be equipped with an operating system operable to support one or more computing and/or communication applications, such as a web browser (not shown), email (not shown), or independently developed applications, the like, to interact with server 205.

The server 205 may thus deliver applications specifically designed for mobile client devices, such as, for example, client device 225. A client device 225 may be any mobile telephone, PDA, tablet or smart phone and may have any device compatible operating system. Such operating systems may include, for example, Symbian, RIM Blackberry OS, Android, Apple iOS, Windows Phone, Palm webOS, Maemo, bada, MeeGo, Brew OS, and Linux for smartphones and tablets. Although many mobile operating systems may be programmed in C++, some may be programmed in Java and .NET, for example. Some operating systems may or may not allow for the use of a proxy server and some may or may not have on-device encryption. Of course, because many of the aforementioned operating systems are proprietary, in prior art embodiments server 205 delivered to client device 225 only those applications and that content applicable to the operating system and platform communication relevant to that client device 225 type.

JavaScript Serialized Object Notation (JSON), a lightweight, text-based, language-independent data-interchange format, is based on a subset of the JavaScript Programming Language, Standard ECMA-262, 3.sup.rd Edition, dated December 1999. JSON syntax is a text format defined with a collection of name/value pairs and an ordered list of values. JSON is very useful for sending structured data over wire (e.g., the Internet) that is lightweight and easy to parse. It is language and platform independent, but uses conventions that are familiar to C-family programming conventions. The JSON language is thus compatible with a great many operating systems (a list of such systems is available at www.json.org).

The techniques described herein may be used for various wireless communication networks, such as CDMA, TDMA, FDMA, OFDMA, SCFDMA, and other wireless networks. The terms “network” and “system” are often used interchangeably herein. By way of example, a CDMA network may implement a radio technology such as Universal Terrestrial Radio Access (UTRA), cdma2000, and the like. For example, an OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMÓ, and the like. UTRA and E-UTRA are part of Universal Mobile Telecommunication System (UMTS). UTRA, E-UTRA, UMTS, as well as long term evolution (LTE) and other cellular techniques, are described in documents from an organization named “3rd Generation Partnership Project” (3GPP) and “3rd Generation Partnership Project 2” (3GPP2), such as, for example, the mobile standards for 5G which will begin in the 3GPP Release 15.

“WiFi” stands for “Wireless Fidelity.” WiFi is typically deployed as a wireless local area network (WLAN) that may extend home and business networks to wireless medium. As referenced, the IEEE 802.11 standard defines WiFi communications as between devices, and as between devices and access points. WiFi typically provides aggregate user data speeds from 2 Mbps (for 802.11b) to approximately 150 Mbps (for 802.11n). Typical speeds for WiFi are around 15 Mbps, and latency (i.e., packet delay) averages around 10 ms with no load. WiFi may link devices, and/or devices and access points, over distances from a few feet to several miles. By way of contrast, LTE, as mentioned above, typically provides WAN connectivity that may stretch for much greater distances, but is typically not preferred for LAN communications. Of note, the techniques described herein may be used for the wireless networks and radio technologies mentioned above, as well as for other wireless networks and radio technologies.

WiFi networks, herein also referred to as IEEE 802.11 wireless networks, may operate in two modes: infrastructure mode and ad-hoc mode. In infrastructure mode, a device connects to an access point (AP) that serves as a hub for connecting wireless devices to the network infrastructure, including, for example, connecting wireless devices to Internet access. Infrastructure mode thus uses a client-server architecture to provide connectivity to the other wireless devices. In contrast to the client-server architecture of infrastructure mode, in ad-hoc mode wireless devices have direct connections to each other in a peer-to-peer architecture.

In various embodiments, a blockchain, or distributed ledger, provides a decentralized approach to tracking information. By eliminating the need for a central authority, information and transactions therewith may be circulated and verified over a network. A blockchain may provide a secure solution for tracking, for example, the ownership and transfer of assets. In a simplified example, a blockchain may provide proof of who owns what at any given point in time and be replicated on hundreds or thousands of computing nodes.

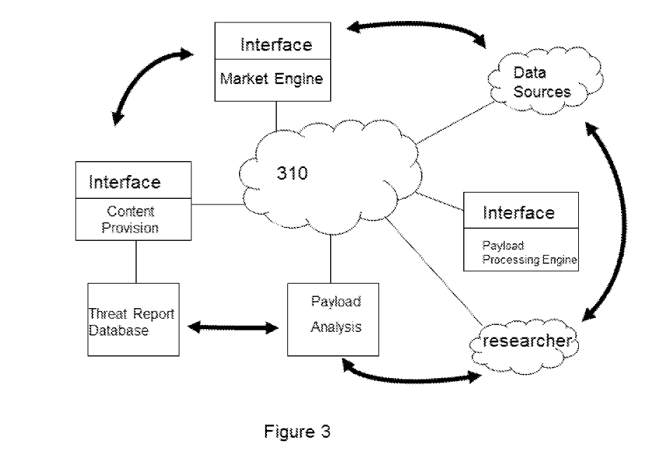

The present invention may also provide an information security marketplace and may facilitate the ability to monetize the information obtained through and generated by an incoming attack on an organization. As illustrated in FIG. 3, the present invention may provide the organization with actionable reports which later may be sold to other organizations in the same market segment or region (e.g. one carrier will buy from other carriers in the same region), or AV vendors, or companies that are interested to buy such threat intelligence information, indicators, etc. The information may be complete or partial (hashes, Indicators of compromise, IPs, etc). This may help organizations to subsidize attack research by monetizing incoming attacks—in many cases, where interesting attacks exists, this can even turn the security operation center into a revenue center and even to a profit center.

The present invention takes a different approach to analyzing samples, and can perform various processes that involves multiple analysts (both manual and automated) going over the same sample, and essentially collaborating (behind the scenes, or directly) with one another, for example. Such steps may include: receiving a suspicious sample; send the analysis to one (crowd sourced or internal) researcher; the researcher may respond: clean sample; send the sample to two other researchers: one reply clean sample and the other reply malicious sample with exact offset or reasons that the researcher believe that sample is malicious; and the present invention sends the exact or partial reasons to the other analysts and ask them to reanalyze based on this finding, or to provide feedback to a specific indicator or reason, and see their responses. Eventually a single response, or multiple responses back to the client are provided by the system.

Based on majority verdicts, or manual and/or automated analysis or other forms, the present invention may determine if a sample is malicious, its risk level and what's the appropriate classification for that sample (malware vs. adware vs . . . ) and can assist to conclude in the intentions (targeted attack vs. widespread attack vs. phishing vs. monetization of ads, etc).

Sample may include, but not limited to any blob that could contain security related data, from files, registry keys, IP addresses, crash dumps, memory dumps, backtrace, exception notes, logs, system logs, services logs, security and network products logs, event logs, drivers, signatures, certificates, system diagnostics, bug reports, and binary files.

The entire Information Security (“infosec”) marketplace for researchers and analysts to get paid for analyzing samples approach as a whole—doesn't exist today. Although there are “bug bounties” where researchers need to find bugs and get paid, there isn't anything in reverse (“Reverse Bounties”) where the researcher need to find a solution or provide an analysis on a specific sample, log data, event or crash information and get paid for such analysis, insights and recommendations. In addition, crowd-sourced approach of feeding technical data of security events, to provide better indication when analyzing payloads, does not exist. Such invention, may include the ability to understand from a crowd-sourced researcher or analyst, what differentiates a legitimate sample to a malicious one. Such verdict can be based on a certain value of specific offset, or a range of values of a certain key, registers values, memory locations, modules hashes, code execution flow, offset sequence, backtrace sequence, etc. Such values can indicate an attempt to trigger a software vulnerability or to launch a payload. One example for such value could be an attempt to trigger buffer overflow/underflow vulnerability, a use-after-free vulnerability, etc., by manipulating one of the expected inputs, to cause unexpected code behavior in an attempt to alter CPU's code execution.

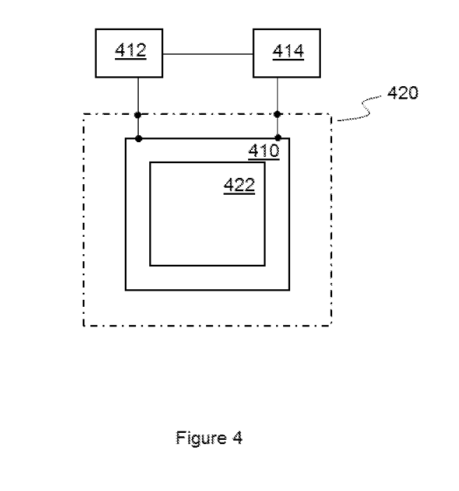

In an embodiment of the present invention, as illustrated in FIG. 4, the watermarking of samples 410 may be used so that during the process of crowdsourcing samples 420, the attributes of the package, such as where a sample had leaked, may be determined and/or tracked. To do that, the present invention may change a few strategic bits in the sample to create a new hash 422 out of this sample. Once identified, such hash 422 in other threat intelligence feeds, we can conclude from which environment, customer or analyst, such sample had leaked. The system will return the watermark to the originally saved sample before feeding in the analysis results back into the organization.

The present invention may create a chain with an automated scanning tool(s) to look for that particular sample in commonly found engines, and even warn the analysts, customer or environment if the accidentally uploaded a sample to a cloud based security scanning service such as VirusTotal® against the rules of engagement that was allowed for such analysis by monitoring those services as the researcher. The results of analysis of multiple samples may lead to the creation of TI collections that can be sold. As part of those collections, we will include one (or more) fake sample(s), as part of a TI collection, when the TI collection gets resold by the customer, its engines or products, against the terms of usage, and arrive into public TIs feeds, we will know where the TI collection leaked from.

The present invention also provides the process of scrambling samples to remove any sensitive wording from documents for upcoming manual scan by an analyst, without damaging the exploited vulnerability in the process. For example, an attacker included confidential information to lure victims from the customer to open the attachment. The attachment was quarantined and uploaded for additional scan. The document contains confidential information that the customer does not wish to share with analysts. The present invention may automatically change all or some of the words, author name, PDB path, images, macros, spreadsheet formulas, UNC paths, signature and other identifying details in the document to an non identifying letter string, such as, “AAAAA AAAAA AAAA” or “**********”, for example, and as a result, when the researcher investigate the document, the exploit still works exactly as planned (we may keep the same size of file, in case of the payload contained in the document itself to prevent such process, we identify such anomalies by looking for encoded messages in multiple forms (such as Base64, alphanumeric shellcodes, etc), but the content of the scrambled file, in case it is unintentionally leaked through configuration, malicious actor or mistakenly uploaded to third party engines, doesn't violate the privacy of the customer and doesn't reveal the sensitive content of the document. The present innovation may also correct the checksum of the sample according to the modified data to avoid damage to the proper execution and research of the sample. The present invention also provides the process of scrambling data to remove any sensitive wording from logs for upcoming manual analysis by human, without damaging the attackers' logic in the process. For example, an attacker infected two devices, one in the DMZ and one in a local network. The computing device on the local network contact the customers' domains and internal PCs such as WSUS.company_name.local and domain_controller.company_name.local. The internal names, as well as the IP address can be changed for the purpose of analysis, without damaging the information. For example: The device on the DMZ has a publicly facing IP, which could be used to identify the exact company—instead of presenting the real IP, we can scramble the address to: 1.1.1.2. The next IP on the same subnet can be changed to 1.1.1.3 and so forth. If we have another subnet, we can simply tweak the subnet on the replaced IP too. Same for the internal DNS names: domain_controller.company_name.local will be changed to domain_controller.example.local. The analyst will still be able to perform the checks, but without the ability to identify the company. The present invention may automatically change all or some of the words, as well as external or internal IPs, paths, URLs and other identifying details in the document to a non identifying letter string, such as, “AAAAAAAAA” or IPs such as “192.168.1.1” or “1.1.1.1”. The present invention also scramble the MAC addresses in log files or PCAP dumps or files associated with an attack, with or without changing the vendor name. For example, a device communicating with 00:01:aa:bb:c1 reveals that the targeted customer contained a CISCO device, due to the identifying OUI (00:01:43) and the actual device (aa:bb:c1). The present invention will scramble the vendor name to a non identifying MAC OUI (such as: 01:01:01) and the device, to a non identifying MAC identifiers (such as: dd:dd:01), resulting in the following scrambled address (01:01:01:dd:dd:01). The present innovation may also provide the ability to descramble the sample in question, for the purpose of the customer viewing the original dataset, source of attack, and other information that were scrambled for the anonymization purposes.

The present invention also allows for the correlation of attacks based on crowd-sourced analytics in a paid/unpaid marketplace. In an embodiment of the present invention, a process may allow for correlating attacks using crowd based analysis of samples. Once a sample is analyzed, the results of such analysis include multiple indicators of compromise (IOCs), such as IP addresses of the attackers' server, hashes of files, forms of operations, persistence methods and other information that can be correlated back to attacks.

The present invention also collect multiple sources of information, such as Windows Event Monitoring, syslog, DNS queries, crash dumps, kernel dumps, quarantined files, blocked emails, spam emails, system diagnostics, crash reports and other available log files, correlate them and presents a timeline of events while alerting on suspicious activity and allowing to correlate attacks.

The present invention allow for an internal researcher, as well as external researcher, to add rules to feeds, that may be used to detect various attacks, or normal behavior, by identifying patterns in multiple sources of information, such as Windows Event Monitoring, syslog, other available log files or other samples as defined above. For example, an addition of a service, or usage of command line as it is reflected in the Windows Event Monitoring. In the present invention, a researcher may be compensated for such feeds and logic, as well as provide the feed with no charge.

The present invention collect samples, user and system logs, either automatically via API, integration, setting up a local or remote reporting service, etc, or manually (by uploading logs), and perform deep analysis to the contents. Such correlation can be performing entropy measurements, standard deviation, cycle analysis, outlier detection, interlacing cycles, to various log requests over time, such as DNS.

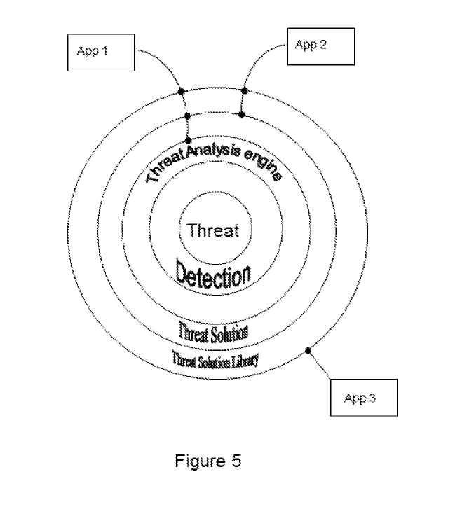

The present invention may also allow for the creating of actionable TI reports for supervised machine learning with, or without in-house human manual labeling, such as illustrated in FIG. 3 and FIG. 5. As a result of a crowd based analysis, the present invention may create a supervised machine-learning model(s) with limited to none in-house involvement. This logic may also be used for other aspects of the present invention.

In an embodiment of the present invention, noise reduction of malicious or non-malicious events using statistical models may be generated by crowdsourced analytics automated analysis, and/or prior manual analysis of samples through the marketplace. As the present invention receives multiple events from multiple devices and multiple companies, it may allow the present invention to have a better decision process to which events can be ignored and flagged as false positive without further investigation, to events that require deeper analysis. The results of which may be bundled and correlated with the previous marketplace analysis results.

The present invention may also allow for a mobile device and every other simulated processing or sandboxed computing system forensics (forensics and attack analysis on a sandboxed computing system). The present invention may also allow an analysis of suspicious activity on a sandboxed device may be processed by receiving a debug entitlement, permission from the vendor, or by running an elevation of privileges exploit or a sandbox escape exploit or exploit chain to get a real status of the operating system outside of the limitations of an unprivileged and sandboxed application or process. This process may allow to benchmark and compare the suspected device to a clean, vanilla system and alert on anomalies for further research. The present invention may not need to bypass the lock screen as this is an approved forensics with the user's permission or its admin to investigate a suspected device.

In an embodiment of the present invention, a second-approval factor for a password/token based authorized command execution in a managed network or domain environment may be used. Second-factor approval for authorized password or token based command execution or file transfer on a remote device that is managed on the same network (e.g. through Active Directory, LDAP or other means). The second approval form may be in a way of a dashboard, portal, or other confirmation mechanism for the IT Admin to approve only legitimate requests. Such functionality may also be bundled with machine learning to determine which computing devices usually talk to one another, and which do not, and what type of commands are expected to execute from remote locations in specific environment and what type of commands are anomalous and require additional approval by the administrator. The present invention support cases where password, or hash of password, is used in order to execute remote code on a target device, without the user's or its administrator consent.

The present invention may also provide an information security engine with its logic separated from its engine. The logic provided by crowd sourced analysts and researchers or inhouse, and the engine itself may support specific functionalities to instrument, hook, check value (bigger, smaller, equal, exact string, >, <, . . . ) bundled with logical operations (OR, AND, . . . ) and multiple responses.

Those of ordinary skill in the art will recognize that many modifications and variations of the present invention may be implemented without departing from the spirit or scope of the invention. Thus, it is intended that the present invention cover the modification and variations of this invention provided they come within the scope of the appended claims and their equivalents.

The various illustrative logics, logical blocks, modules, and engines, described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of instructions on a machine readable medium and/or computer readable medium.

It is appreciated that the exemplary computing system is merely illustrative of a computing environment in which the herein described systems and methods may operate, and thus does not limit the implementation of the herein described systems and methods in computing environments having differing components and configurations. That is, the inventive concepts described herein may be implemented in various computing environments using various components and configurations.

Those of skill in the art will appreciate that the herein described apparatuses, engines, devices, systems and methods are susceptible to various modifications and alternative constructions. There is no intention to limit the scope of the invention to the specific constructions described herein. Rather, the herein described systems and methods are intended to cover all modifications, alternative constructions, and equivalents falling within the scope and spirit of the disclosure, any appended claims and any equivalents thereto.

In the foregoing detailed description, it may be that various features are grouped together in individual embodiments for the purpose of brevity in the disclosure. This method of disclosure is not to be interpreted as reflecting an intention that any subsequently claimed embodiments require more features than are expressly recited.

Further, the descriptions of the disclosure are provided to enable any person skilled in the art to make or use the disclosed embodiments. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but rather is to be accorded the widest scope consistent with the principles and novel features disclosed herein.

1. A computer-implemented engine for generating threat intelligence, over a network, responsively to input customer information comprising at least one certified information input, comprising:
a graphical user interface capable of locally querying an origination engine for the input customer information comprising at least general consumer information and the at least one certified information input, wherein the at least general consumer information comprises a malware code, anomaly, or legitimate behavior;
at least one network port capable of remotely receiving the consumer information from said graphical user interface; and
at least one rules engine communicatively connected to said at least one network port, and comprising a plurality of rules to generate, responsively to the input consumer information, a set of rules to resolve the malware code for offer to at least one consumer.

2. A method for analyzing samples, the method comprising:
receiving at least one sample;
sending the at least one sample to at least two researchers;
receiving responses from each of the at least two researchers;
determining whether the sample is malicious based on the responses received from each of the at least two researchers; and
reporting said determination to at least one user.

3. The method of claim 2, wherein determining whether the sample is malicious further comprises:
sending for re-analysis in response to at least one of the responses indicates suspicious/malicious threat.

4. The method of claim 3, wherein re-analysis is automated.

5. The method of claim 3, wherein re-analysis is manual.

6. The method of claim 2, wherein the determination indicates malicious or clean.

7. The method of claim 2, wherein the at least one sample is sent to a crowdsource.

8. The method of claim 2, wherein the reply indicates exact reasons for a malicious indication.

9. The method of claim 2, wherein the reply indicates partial reasons for a malicious indication.

10. The method of claim 2, further comprising:
providing the determination in a report to be sold on a security marketplace.

11. A system for providing a cyberattack prevention security marketplace, the system comprising:
at least one memory coupled to at least one processor comprising executable instructions when executed by the processor are configured to:
provide an information security marketplace; and
facilitate the ability to monetize the information obtained through and generated by an incoming attack on an organization.

12. The system of claim 11, the processor is further configured to:
provide the organization with actionable reports; and
sell to other organizations threat intelligence information or indicators.

13. The system of claim 12, wherein the information may be complete or partial.

14. The system of claim 13, wherein the information includes at least one of: hashes, indicators of compromise, or IP addresses.

15. The system of claim 13, wherein the information includes security related data and at least one of: files, registry keys, IP addresses, crash dumps, memory dumps, backtrace, exception notes, logs, system logs, services logs, security and network products logs, event logs, drivers, signatures, certificates, system diagnostics, bug reports, and binary files.
